(19) United States
(12) Patent Application Publication
(10) Pub. No.: US 2024/0214952 A1
(43) Pub. Date: Jun. 27, 2024

(54) RADIO FREQUENCY EXPOSURE MANAGEMENT FOR AUTHORIZED EXCEPTIONS

(71) Applicant: QUALCOMM Incorporated, San Diego, CA (US)

(72) Inventors: Lin LU, San Diego, CA (US); Jagadish NADAKUDUTI, Bermuda Dunes, CA (US); Paul GUCKIAN, La Jolla, CA (US)

(21) Appl. No.: 18/390,591

(22) Filed: Dec. 20, 2023

Related U.S. Application Data
(60) Provisional application No. 63/476,611, filed on Dec. 21, 2022.

(51) Int. Cl. H04W 52/36

(52) U.S. Cl. CPC H04W 52/367

(57) ABSTRACT

Techniques and apparatus for managing exceptions to radio frequency (RF) exposure compliance are described. An example method of wireless communication by a wireless device generally includes detecting a transmission is associated with an authorized exception to RF exposure compliance. The method also includes determining an allowable transmit power level for a time interval independent of a time-averaged RF exposure limit in response to detecting the transmission is associated with the authorized exception. The method further includes transmitting a signal in the time interval based on the allowable transmit power level.

### CROSS-REFERENCE TO RELATED APPLICATION

This application claims the benefit of U.S. Provisional Patent Application Ser. No. 63/476,611, filed Dec. 21, 2022, which is hereby incorporated by reference herein in its entirety for all applicable purposes.

### INTRODUCTION

### Field of the Disclosure

Aspects of the present disclosure relate to wireless communications, and more particularly, to managing exceptions to radio frequency (RF) exposure compliance.

### Description of Related Art

Wireless communication systems are widely deployed to provide various telecommunication services such as telephony, video, data, messaging, broadcasts, etc. Modern wireless devices (such as cellular telephones) are generally mandated to meet radio frequency (RF) exposure limits set by certain governments and international standards and regulations. To ensure compliance with the standards, such devices typically undergo an extensive certification process prior to being shipped to market. To ensure that a wireless device complies with an RF exposure limit, techniques have been developed to enable the wireless device to assess RF exposure from the wireless device and adjust the transmission power of the wireless device accordingly to comply with the RF exposure limit.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide various advantages.

Certain aspects of the subject matter described in this disclosure can be implemented in a method for wireless communication by a wireless device. The method generally includes detecting a transmission is associated with an authorized exception to radio frequency (RF) exposure compliance. The method further includes determining an allowable transmit power level for a time interval independent of a time-averaged RF exposure limit in response to detecting the transmission is associated with the authorized exception. The method also includes transmitting a signal in the time interval based on the allowable transmit power level.

Certain aspects of the subject matter described in this disclosure can be implemented in an apparatus for wireless communication. The apparatus includes one or more memories collectively storing executable instructions, and one or more processors coupled to the one or more memories. The one or more processors are collectively configured to execute the executable instructions to cause the apparatus to detect a transmission is associated with an authorized exception to radio frequency (RF) exposure compliance, determine an allowable transmit power level for a time interval independent of a time-averaged RF exposure limit in response to detecting the transmission is associated with the authorized exception, and transmit a signal in the time interval based on the allowable transmit power level.

Certain aspects of the subject matter described in this disclosure can be implemented in an apparatus for wireless communication. The apparatus includes means for detecting a transmission is associated with an authorized exception to radio frequency (RF) exposure compliance. The apparatus also includes means for determining an allowable transmit power level for a time interval independent of a time-averaged RF exposure limit in response to detecting the transmission is associated with the authorized exception. The apparatus further includes means for transmitting a signal in the time interval based on the allowable transmit power level.

Certain aspects of the subject matter described in this disclosure can be implemented in a non-transitory computer-readable medium. The non-transitory computer-readable medium has instruction stored thereon, which when executed by an apparatus, cause the apparatus to perform an operation. The operation includes detecting a transmission is associated with an authorized exception to radio frequency (RF) exposure compliance. The operation also includes determining an allowable transmit power level for a time interval independent of a time-averaged RF exposure limit in response to detecting the transmission is associated with the authorized exception. The operation further includes transmitting a signal in the time interval based on the allowable transmit power level.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network.

FIG. 2 is a block diagram conceptually illustrating a design of an example base station (BS) and user equipment (UE).

FIG. 3 is a block diagram of an example radio frequency (RF) transceiver.

FIGS. 4A, 4B, and 4C are graphs illustrating examples of transmit powers over time in compliance with a time-averaged RF exposure limit.

FIG. 5 is a flow diagram illustrating example operations for managing a time-averaged RF exposure evaluation for an authorized exception, in accordance with certain aspects of the present disclosure.

FIG. 6 illustrates a graph of example (normalized) transmit powers over time relative to a maximum time-averaged transmit power level, in accordance with certain aspects of the present disclosure.

FIG. 7A is an example plot illustrating instantaneous normalized exposure over time associated with a wireless device, in accordance with certain aspects of the present disclosure.

FIG. 7B is an example plot illustrating the time-averaged normalized exposure corresponding to FIG. 7A, in accordance with certain aspects of the present disclosure.

FIG. 8 is a flow diagram illustrating example operations for wireless communication by a wireless device, in accordance with certain aspects of the present disclosure.

FIG. 9 illustrates a communications device (e.g., a UE) that may include various components configured to perform operations for the techniques disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer-readable mediums for managing exceptions to radio frequency (RF) exposure compliance.

A wireless communications device may evaluate RF exposure compliance using a time-averaged operation over a running time window (e.g., 4 seconds for millimeter wave (mmWave), 2 seconds for 60 gigahertz (GHz) bands, 100 or 360 seconds for bands less than or equal to 6 GHz, etc.). The wireless device may perform the RF exposure assessment of past RF exposure over a given time window to determine a maximum allowable transmit power for a future time interval in the time window. The time-averaged RF exposure evaluation may allow the wireless device to output high power transmission burst(s) in compliance with the time-averaged RF exposure limit. For example, a high power transmission burst may use most or all of the exposure margin associated with the time-averaged RF exposure limit in a short duration relative to the time window. In some cases, after the high power transmission burst, the wireless device may refrain from transmitting (e.g., drop a call) or maintain the transmit power at a reserve level for the remainder of the time window to ensure compliance with the time-averaged RF exposure limit. In such cases, the wireless device may be unable to make or maintain an emergency transmission, such as a 9-1-1 call or other emergency transmission as further described herein, until the time-averaged RF exposure margin is renewed following the passing of the time window, which can be as long as six minutes in some cases.

Aspects of the present disclosure provide apparatus and methods for managing exceptions to RF exposure compliance. The wireless device may apply a temporary exception to the time-averaged RF exposure limit for certain transmissions, such as an emergency transmission. For example, in response to detecting an authorized exception to RF exposure compliance (e.g., an emergency transmission), the wireless device may output the emergency transmission at a power level that violates the time-averaged RF exposure limit given the past exposure of the wireless device. In some cases, the power level may be the maximum instantaneous transmit power that the wireless device is capable of outputting or a power level determined by a regulator or standards body. In certain cases, the power level may be at a level corresponding to the time-averaged RF exposure limit. The wireless device may allow the time-averaged RF exposure to violate the time-averaged RF exposure limit for a certain duration, such as a time window associated with the time-averaged RF exposure limit or until the transmission is successfully received.

The apparatus and methods for managing exceptions to RF exposure compliance described herein may enable a wireless device to communicate with another wireless device in an emergency situation (or other authorized exception scenario) regardless of the past exposure generated by the wireless device. For example, assuming the wireless device has consumed all or most of the exposure margin in a time window associated with a time-averaged RF exposure limit, the wireless device may output an emergency transmission (or other authorized exception transmission) regardless of the past RF exposure generated by the wireless device.

The following description provides examples of RF exposure compliance in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs, or may support multiple RATs.

The techniques described herein may be used for various wireless networks and radio technologies. While aspects may be described herein using terminology commonly associated with Third Generation (3G), Fourth Generation (4G), and/or new radio (NR) (e.g., Fifth Generation (5G) NR) wireless technologies, aspects of the present disclosure can be applied in other generation-based communication systems and/or to wireless technologies such as 802.11, 802.15, etc.

NR access may support various wireless communication services, such as enhanced mobile broadband (eMBB) targeting wide bandwidth (e.g., 80 megahertz (MHz) or beyond), mmWave targeting high carrier frequency (e.g., 24 GHz to 53 GHz or beyond), massive machine type communications (MTC) (mMTC) targeting non-backward compatible MTC techniques, and/or mission critical targeting ultra-reliable low-latency communications (URLLC). These services may include latency and reliability specifications. These services may also have different transmission time intervals (TTIs) to meet respective quality of service (QoS) specifications. In addition, these services may co-exist in the same subframe. NR supports beamforming, and beam direction may be dynamically configured. Multiple-input, multiple-output (MIMO) transmissions with precoding may also be supported, as may multi-layer transmissions. Aggregation of multiple cells may be supported.

### Example Wireless Communication Network and Devices

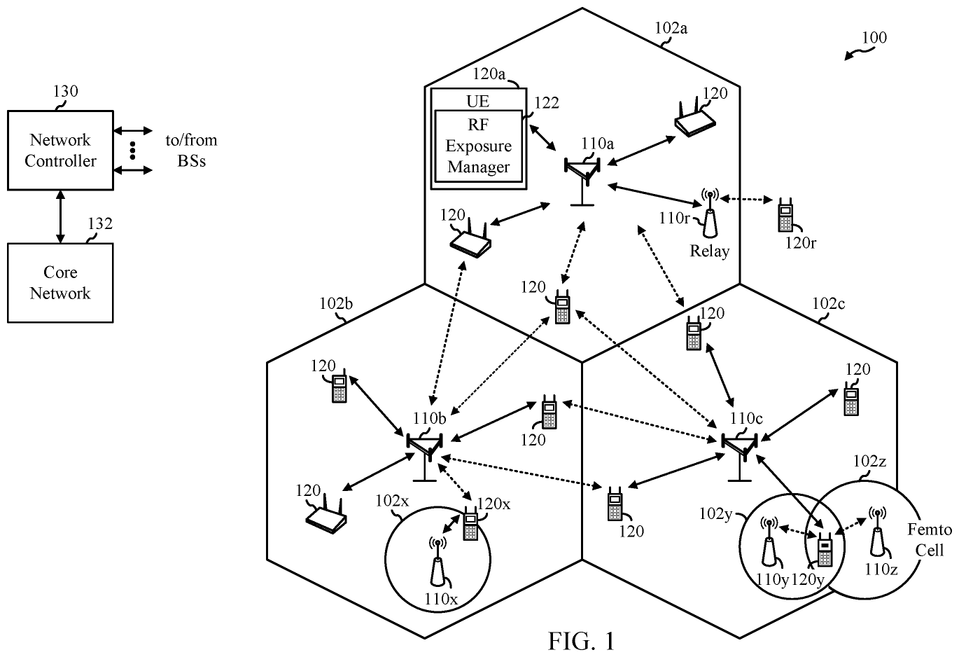

FIG. 1 illustrates an example wireless communication network 100 in which aspects of the present disclosure may be performed. For example, the wireless communication network 100 may be an NR system (e.g., a 5G NR network), an Evolved Universal Terrestrial Radio Access (E-UTRA) system (e.g., a 4G network), a Universal Mobile Telecommunications System (UMTS) (e.g., a Second Generation (2G)/Third Generation (3G) network), or a code division multiple access (CDMA) system (e.g., a 2G/3G network), or may be configured for communications according to an IEEE standard such as one or more of the 802.11 standards, etc. As shown in FIG. 1, the UE 120a includes an RF exposure manager 122 that manages authorized exception(s) to time-averaged RF exposure compliance, in accordance with aspects of the present disclosure. The UE 120a may be configured to communicate with multiple radio access networks (RANs), such as with a 5G network and a WiFi network, or configured to communicate with a single RAN, for example only a WiFi network or only a Bluetooth network.

As illustrated in FIG. 1, the wireless communication network 100 may include a number of BSs 110a-110z (each also individually referred to herein as BS 110 or collectively as BSs 110) and other network entities. A BS 110 may provide communication coverage for a particular geographic area, sometimes referred to as a “cell,” which may be stationary or may move according to the location of a mobile BS. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b, and 110c may be macro BSs for the macro cells 102a, 102b, and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with UEs 120a-120y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

In certain aspects, the UE 120a may act as an access point (AP) (such as a soft-AP) and communicate with other WiFi clients (e.g., augmented reality (AR) glasses or headset, tablets, etc.) and use the wireless link to the BS 110 as a backhaul to a network (e.g., the Internet). As an example, the UE 120a may stream video from an AP (e.g., another UE or base station) and have a Bluetooth link to a pair of headsets.

A network controller 130 may be in communication with a set of BSs 110 and provide coordination and control for these BSs 110 (e.g., via a backhaul). In certain cases, the network controller 130 may include a centralized unit (CU) and/or a distributed unit (DU), for example, in a 5G NR system. In some aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

The term “beam” may be used in the present disclosure in various contexts. Beam may be used to mean a set of gains and/or phases (e.g., pre-coding weights or co-phasing weights) applied to antenna elements in the UE and/or BS for transmission or reception. The term “beam” may also refer to an antenna or radiation pattern of a signal transmitted while applying the gains and/or phases to the antenna elements. Other references to beam may include one or more properties or parameters associated with the antenna (radiation) pattern, such as angle of arrival (AoA), angle of departure (AoD), gain, phase, directivity, beam width, beam direction (with respect to a plane of reference) in terms of azimuth and elevation, peak-to-side-lobe ratio, or an antenna port associated with the antenna (radiation) pattern. The term “beam” may also refer to an associated number and/or configuration of antenna elements (e.g., a uniform linear array, a uniform rectangular array, or other uniform array).

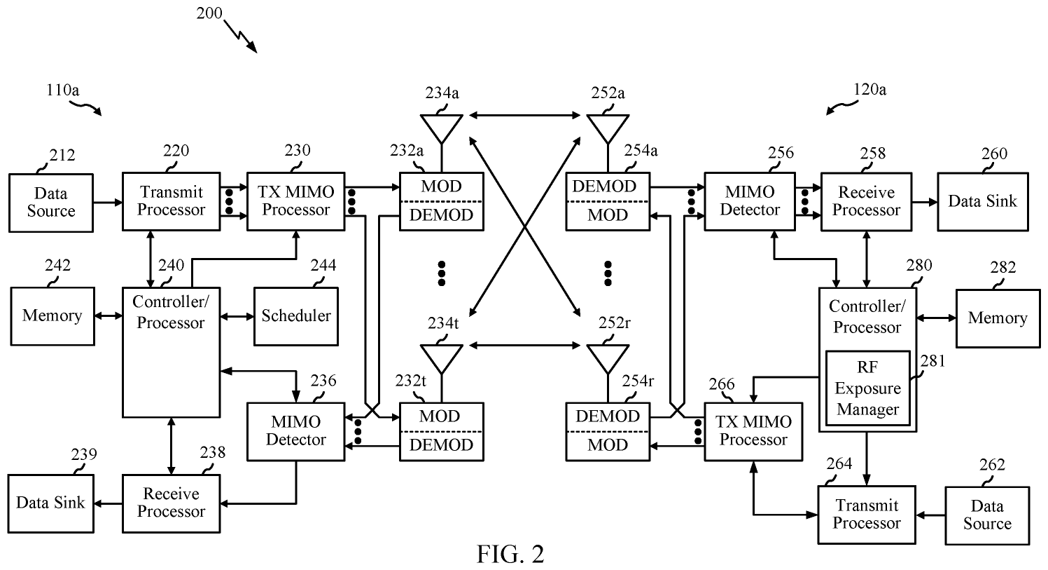

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for orthogonal frequency division multiplexing (OFDM), etc.) to obtain an output sample stream. Each of the transceivers 232a-232t may further process (e.g., convert to analog, amplify, filter, and upconvert) the output sample stream to obtain a downlink signal. Downlink signals from the transceivers 232a-232t may be transmitted via the antennas 234a-234t, respectively.

At the UE 120a, the antennas 252a-252r may receive the downlink (DL) signals from the BS 110a and may provide received signals to the transceivers 254a-254r, respectively. The transceivers 254a-254r may condition (e.g., filter, amplify, downconvert, and digitize) a respective received signal to obtain input samples. Each demodulator (DEMOD) in the transceivers 232a-232t may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH)) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators (MODs) in transceivers 254a-254r (e.g., for single-carrier frequency division multiplexing (SC-FDM), etc.), and transmitted to the BS 110a. At the BS 110a, the uplink (UL) signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. As shown in FIG. 2, the controller/processor 280 of the UE 120a has an RF exposure manager 281 that is representative of the RF exposure manager 122, according to aspects described herein. Although shown at the controller/processor, other components of the UE 120a and BS 110a may be used to perform the operations described herein.

NR may utilize OFDM with a cyclic prefix (CP) on the uplink and downlink. NR may support half-duplex operation using time division duplexing (TDD). OFDM and SC-FDM partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The system bandwidth may also be partitioned into subbands. For example, a subband may cover multiple resource blocks (RBs).

While the UE 120a is described with respect to FIGS. 1 and 2 as communicating with a BS and/or within a network, the UE 120a may be configured to communicate directly with/transmit directly to another UE 120, or with/to another wireless device without relaying communications through a network. In some aspects, the BS 110a illustrated in FIG. 2 and described above is an example of another UE 120.

### Example RF Transceiver

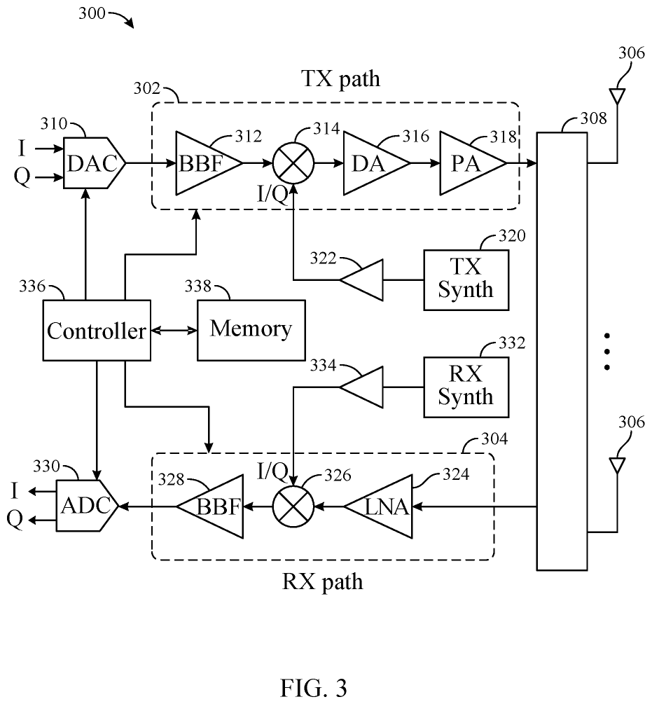

FIG. 3 is a block diagram of an example RF transceiver circuit 300, in accordance with certain aspects of the present disclosure. The RF transceiver circuit 300 includes at least one transmit (TX) path 302 (also known as a transmit chain) for transmitting signals via one or more antennas 306 and at least one receive (RX) path 304 (also known as a receive chain) for receiving signals via the antennas 306. When the TX path 302 and the RX path 304 share an antenna 306, the paths may be connected with the antenna via an interface 308, which may include any of various suitable RF devices, such as a switch, a duplexer, a diplexer, a multiplexer, and the like.

Receiving in-phase (I) or quadrature (Q) baseband analog signals from a digital-to-analog converter (DAC) 310, the TX path 302 may include a baseband filter (BBF) 312, a mixer 314, a driver amplifier (DA) 316, and a power amplifier (PA) 318. The BBF 312, the mixer 314, and the DA 316 may be included in one or more radio frequency integrated circuits (RFICs). The PA 318 may be external to the RFIC(s) for some implementations.

The BBF 312 filters the baseband signals received from the DAC 310, and the mixer 314 mixes the filtered baseband signals with a transmit local oscillator (LO) signal to convert the baseband signal of interest to a different frequency (e.g., upconvert from baseband to a radio frequency). This frequency conversion process produces the sum and difference frequencies between the LO frequency and the frequencies of the baseband signal of interest. The sum and difference frequencies are referred to as the beat frequencies. The beat frequencies are typically in the RF range, such that the signals output by the mixer 314 are typically RF signals, which may be amplified by the DA 316 and/or by the PA 318 before transmission by the antenna 306. While one mixer 314 is illustrated, several mixers may be used to upconvert the filtered baseband signals to one or more intermediate frequencies and to thereafter upconvert the intermediate frequency signals to a frequency for transmission.

The RX path 304 may include a low noise amplifier (LNA) 324, a mixer 326, and a baseband filter (BBF) 328. The LNA 324, the mixer 326, and the BBF 328 may be included in one or more RFICs, which may or may not be the same RFIC that includes the TX path components. RF signals received via the antenna 306 may be amplified by the LNA 324, and the mixer 326 mixes the amplified RF signals with a receive local oscillator (LO) signal to convert the RF signal of interest to a different baseband frequency (e.g., downconvert). The baseband signals output by the mixer 326 may be filtered by the BBF 328 before being converted by an analog-to-digital converter (ADC) 330 to digital I or Q signals for digital signal processing.

Certain transceivers may employ frequency synthesizers with a voltage-controlled oscillator (VCO) to generate a stable, tunable LO with a particular tuning range. Thus, the transmit LO may be produced by a TX frequency synthesizer 320, which may be buffered or amplified by amplifier 322 before being mixed with the baseband signals in the mixer 314. Similarly, the receive LO may be produced by an RX frequency synthesizer 332, which may be buffered or amplified by amplifier 334 before being mixed with the RF signals in the mixer 326.

A controller 336 may direct the operation of the RF transceiver circuit 300, such as transmitting signals via the TX path 302 and/or receiving signals via the RX path 304. The controller 336 may be a processor, a digital signal processor (DSP), an application specific integrated circuit (ASIC), a field programmable gate array (FPGA) or other programmable logic device (PLD), discrete gate or transistor logic, discrete hardware components, or any combination thereof. The memory 338 may store data and program codes for operating the RF transceiver circuit 300. The controller 336 and/or memory 338 may include control logic. In certain cases, the controller 336 may determine a transmit power applied to the TX path 302 (e.g., certain levels of gain applied to the

BBF 312, the DA 316, and/or the PA 318) that complies with an RF exposure limit set by country-specific regulations and/or international standards as further described herein.

### Example RF Exposure Compliance

RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm²). In certain cases, a maximum permissible exposure (MPE) limit in terms of PD may be imposed for wireless devices using transmission frequencies above 6 GHz. The MPE limit is a regulatory metric for exposure based on area, e.g., an energy density limit defined as a number, X, watts per square meter (W/m²) averaged over a defined area and time-averaged over a frequency-dependent time window in order to prevent a human exposure hazard represented by a tissue temperature change.

SAR may be used to assess RF exposure for transmission frequencies less than 6 GHz, which cover wireless communication technologies such as 2G/3G (e.g., CDMA), 4G (e.g., Long Term Evolution (LTE)), 5G (e.g., NR in 6 GHz bands), IEEE 802.11ac, etc. PD may be used to assess RF exposure for transmission frequencies higher than 6 GHz, which cover wireless communication technologies such as IEEE 802.11ad, 802.11ay, 5G in mmWave bands, etc. Thus, different metrics may be used to assess RF exposure for different wireless communication technologies.

A wireless device (e.g., UE 120) may simultaneously transmit signals using multiple wireless communication technologies. For example, the wireless device may simultaneously transmit signals using a first wireless communication technology operating at or below 6 GHz (e.g., 3G, 4G, 5G, etc.) and a second wireless communication technology operating above 6 GHz (e.g., mmWave 5G in 24 to 60 GHz bands, IEEE 802.11ad or 802.11ay). In certain aspects, the wireless device may simultaneously transmit signals using the first wireless communication technology (e.g., 3G, 4G, 5G in sub-6 GHz bands, IEEE 802.11ac, etc.) in which RF exposure is measured in terms of SAR, and the second wireless communication technology (e.g., 5G in 24 to 60 GHz bands, IEEE 802.11ad, 802.11ay, etc.) in which RF exposure is measured in terms of PD. As used herein, sub-6 GHz bands may include frequency bands of 300 MHz to 6,000 MHz in some examples, and may include bands in the 6,000 MHz and/or 7,000 MHz range in some examples.

In certain cases, compliance with an RF exposure limit may be performed as a time-averaged RF exposure evaluation within a specified time window (T) (e.g., 4 seconds for mmWave, 2 seconds for 60 GHz bands, 100 or 360 seconds for bands less than or equal to 6 GHz, etc.) associated with the RF exposure limit.

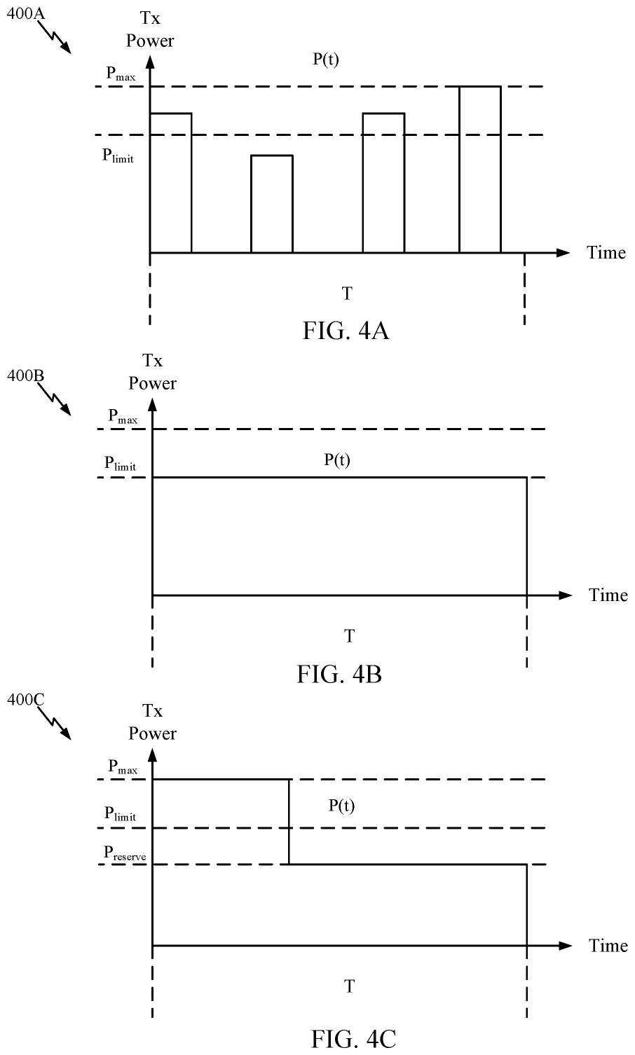

FIG. 4A is a graph 400A of a transmit power over time (P(t)) that varies over a running time window (T) associated with a time-averaged RF exposure limit, in accordance with certain aspects of the present disclosure. As an example, the instantaneous transmit power may exceed a maximum time-averaged transmit power level Pₗᵢₘᵢₜ in certain transmission occasions in the time window (T). The transmit power may be greater than the maximum time-averaged transmit power level Pₗᵢₘᵢₜ for certain durations. In certain cases, the wireless device may transmit at Pₘₐₓ, which is the maximum transmit power that the wireless device is capable of outputting. In certain cases, the wireless device may transmit at a transmit power less than or equal to the maximum time-averaged transmit power level Pₗᵢₘᵢₜ in certain transmission occasions. The maximum time-averaged transmit power level Pₗᵢₘᵢₜ represents the time-averaged threshold in terms of transmit power for the RF exposure limit over the time window (T). In certain cases, Pₗᵢₘᵢₜ may be referred to as the maximum time-averaged power level or limit, or in terms of exposure, the maximum time-averaged RF exposure level or limit. The graph 400A also illustrates gaps between transmission bursts, where the gaps represent periods during which no transmission is output from the wireless device.

In certain cases, the transmit power may be maintained at the maximum time-averaged transmit power level (e.g., Pₗᵢₘᵢₜ) allowed for RF exposure compliance that enables continuous transmission during the time window. For example, FIG. 4B is a graph 400B of a transmit power over time (P(t)) illustrating an example where the transmit power is set to Pₗᵢₘᵢₜ, in accordance with certain aspects of the present disclosure. As shown, the UE can transmit continuously at Pₗᵢₘᵢₜ in compliance with the time-averaged RF exposure limit.

FIG. 4C is a graph 400C of a transmit power over time (P(t)) illustrating a time-averaged mode that provides a reserve power to enable a continuous transmission within the time window (T), in accordance with certain aspects of the present disclosure. As shown, the transmit power may be backed off from the maximum instantaneous power (Pₘₐₓ) to a reserve power (Pᵣₑₛₑᵣᵥₑ) so that the UE can continue transmitting at the lower power (Pᵣₑₛₑᵣᵥₑ) to maintain a continuous transmission during the time window (e.g., maintain a radio connection with a receiving entity). In FIG. 4C, the area between Pₘₐₓ and Pᵣₑₛₑᵣᵥₑ for the time duration of Pₘₐₓ may be equal to the area between Pₗᵢₘᵢₜ and Pᵣₑₛₑᵣᵥₑ for the time window T, such that the area of transmit power (P(t)) in FIG. 4C is equal to the area of Pₗᵢₘᵢₜ for the time window T. Such an area may be considered using 100% of the energy (transmit power or exposure) to remain compliant with the time-averaged RF exposure limit. Without the reserve power Pᵣₑₛₑᵣᵥₑ, the transmitter may transmit at Pₘₐₓ for a portion of the time window with the transmitter turned off for the remainder of the time window to ensure compliance with the time-averaged RF exposure limit. In some aspects, Pᵣₑₛₑᵣᵥₑ is set at a fixed power used to serve for a purpose (e.g., reserving power for certain communications). The transmit duration at Pₘₐₓ may be referred to as the burst transmit time (or high power duration). When more margin is available in the future (after T seconds), the transmitter may be allowed to transmit at a higher power again (e.g., in short bursts at Pₘₐₓ).

In some aspects, the UE may transmit at a power that is higher than the average power level, but less than Pₘₐₓ in the time-averaged mode illustrated in FIG. 4C. While a single transmit burst is illustrated in FIG. 4C, it will be understood that the UE may instead utilize multiple transmit bursts within the time window (T), for example, as described herein with respect to FIG. 4A, where the transmit bursts may be separated by periods during which the transmit power is maintained at or below Pᵣₑₛₑᵣᵥₑ. Further, it will be understood that the transmit power of each transmit burst may vary (either within the burst and/or in comparison to other bursts), and that at least a portion of the burst may be transmitted at a power above the maximum average power level (e.g., Pₗᵢₘᵢₜ).

While FIGS. 4A-4C illustrate continuous transmission over a window, occasion, burst, etc., it will be understood that a duty cycle for transmission may be implemented. In such implementations, a transmit power may be zero during certain portions of the duty cycle and maintained at a higher level (e.g., a level as illustrated in FIGS. 4A-4C) during other portions of the duty cycle. As used herein, the duty cycle of the transmission may be representative of a portion (e.g., 5 ms) of a specific period (e.g., 500 ms) in which one or more signals are transmitted. In certain cases, the duty cycle may be standardized (e.g., predetermined) with a specific RAT and/or vary over time, for example, due to changes in radio conditions, mobility, user behavior, channel availability, etc.

The time-averaged RF exposure evaluation may allow the wireless device to output high power transmission burst(s) in compliance with the time-averaged RF exposure limit, for example, as depicted in FIGS. 4A and 4C. A high power transmission burst may use most or all of the exposure margin associated with the time-averaged RF exposure limit in a short duration relative to the time window. In some cases, after the high power transmission burst, the wireless device may refrain from transmitting (e.g., drop a call) or maintain the transmit power at a reserve level for the remainder of the time window to ensure compliance with the time-averaged RF exposure limit. For example, suppose the wireless device uses all of the available energy associated with a time-averaged RF exposure limit in the last time interval of a time window. If an emergency transmission was initiated at this time, the wireless device may delay the emergency transmission for almost one time window (e.g., six minutes). If the wireless device uses a reserve, the reserve power may be too low to communicate with another wireless device. In such cases, the wireless device may be unable to make an emergency transmission, such as a 9-1-1 call or other emergency transmission as further described herein, until the time-averaged RF exposure margin is renewed following the passing of the time window, which can be as long as six minutes in some cases.

### Example Radio Management of Authorized Exceptions to Radio Frequency Compliance

Aspects of the present disclosure provide apparatus and methods for managing exceptions to RF exposure compliance. The wireless device may apply a temporary exception to the time-averaged RF exposure limit for certain transmissions, such as an emergency transmission. For example, in response to detecting an authorized exception to RF exposure compliance (e.g., an emergency transmission), the wireless device may output the emergency transmission at a power level that violates the time-averaged RF exposure limit given the past exposure of the wireless device. In some cases, the power level may be the maximum instantaneous transmit power that the wireless device is capable of outputting. In certain cases, the power level may be at a level corresponding to the time-averaged RF exposure limit or at some other predefined power level for such exceptions. The wireless device may allow the time-averaged RF exposure to violate the time-averaged RF exposure limit for a certain duration, such as a time window associated with the time-averaged RF exposure limit.

The apparatus and methods for managing exceptions to RF exposure compliance described herein may enable a wireless device to communicate with another wireless device in an emergency situation (or other authorized exception scenario) regardless of the past exposure generated by the wireless device. For example, assuming the wireless device has consumed all or most of the exposure margin in a time window associated with a time-averaged RF exposure limit, the wireless device may output an emergency transmission (or other authorized exception transmission) regardless of the past RF exposure generated by the wireless device. The apparatus and methods for managing exceptions to RF exposure compliance described herein may also allow a wireless device to switch between operating in compliance with an RF exposure limit and applying an authorized exception to RF exposure compliance.

In certain aspects, the wireless device may allow one or more signals to be transmitted at an exception transmit power level (P_{excep}) in response to detecting an authorized exception to RF exposure compliance. The exception transmit power level (P_{excep}) may result in the wireless device being temporarily non-compliant with a time-averaged RF exposure limit. In some cases, P_{excep} may be the maximum transmit power that the wireless device is capable of outputting (e.g., Pₘₐₓ). In certain cases, the power level may be the maximum time-averaged transmit power level (Pₗᵢₘᵢₜ) corresponding to the time-averaged RF exposure limit. For certain aspects, the wireless device may select the power level for P_{excep}from a range of powers including Pₗᵢₘᵢₜ to Pₘₐₓ or any transmit power level that is less than or equal to Pₘₐₓ.

For some cases, the wireless device may temporarily stop (or refrain) from performing a time-averaged RF exposure evaluation during an emergency transmission, and the wireless device may resume performing the time-averaged RF exposure evaluation in response to the emergency transmission ending. In such a scenario, when the time-averaged RF exposure evaluation resumes, the wireless device may substitute the RF exposure history corresponding to the emergency transmission with one or more values that are in compliance with the time-averaged RF exposure limit as described herein.

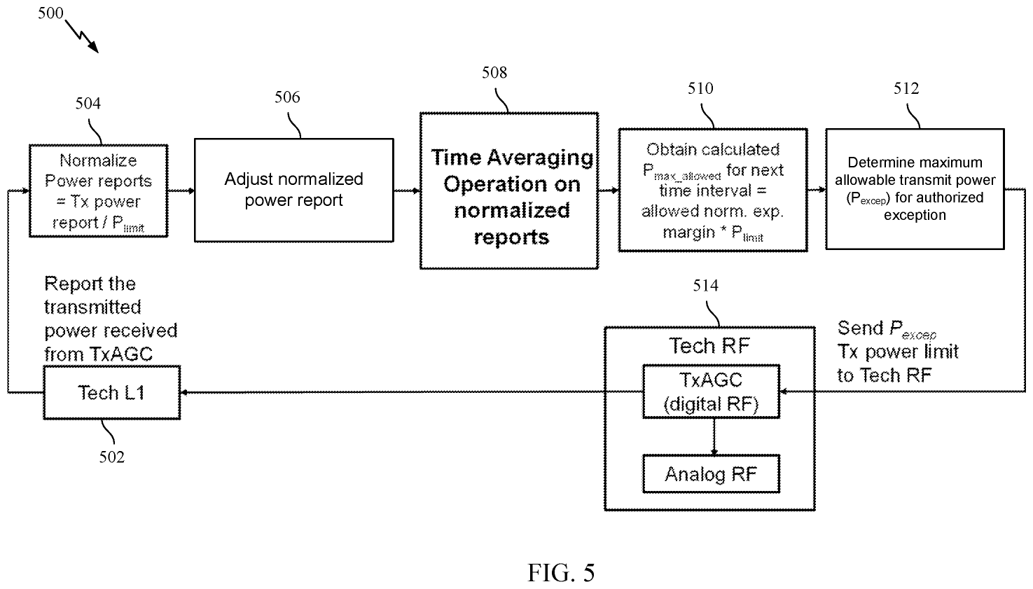

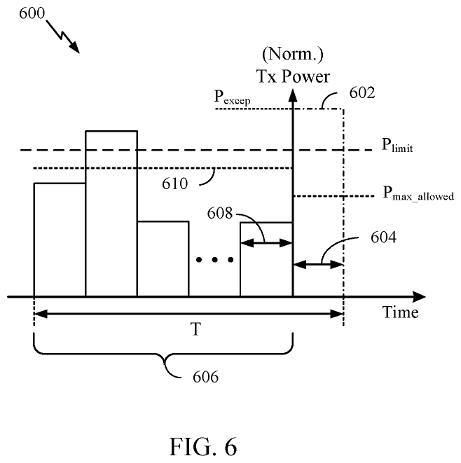

For certain aspects, the wireless device may adjust the RF exposure history (or transmit power history) tracked for time-averaged RF exposure evaluation (e.g., in the case of an authorized exception scenario). Such an adjustment may prevent the time-averaged RF exposure evaluation from crashing (e.g., a major computing failure due to non-compliance with the RF exposure limit) or interfering with an emergency transmission (e.g., delaying the transmission or reducing P_{excep}). If the wireless device keeps transmitting at P_{excep} continuously, the time-averaged RF exposure evaluation may crash without further action due to non-compliance with the RF exposure limit. For smooth operation from a software operation point of view, on the power reporting side, the wireless device may replace the actual transmit power report (which is representative of past RF exposure produced by the wireless device in the running time window) with a substitute transmit power report that may be in compliance with the time-averaged RF exposure limit or may otherwise prevent crashing. The substitute transmit power report may be a substitute (or replacement) or dummy (or mock) report that may be used to determine a maximum allowable transmit power, and the maximum allowable transmit power may be replaced with the exception transmit power level, as further described herein with respect to FIGS. 5 and 6. The wireless device may substitute the past exposure or past transmit powers with one or more values that are in compliance with the time-averaged RF exposure limit. For example, the wireless device may set the actual past exposure to an amount that is less than the time-averaged RF exposure limit. In certain cases, the wireless device may set the past exposure to a value that is representative of no exposure (e.g., an average of zero over the time window or zeroes for multiple time intervals associated with the past exposure) or to some other predefined value. In certain cases, the wireless device may set the past exposure to a reserve power level (e.g., Pᵣₑₛₑᵣᵥₑ).

In some cases, the wireless device may select a substitute power report from multiple values. For example, the wireless device may select the smallest value for the substitute power report among the actual transmit power report value and a substitute value (e.g., min(actual transmit power report, the last computed power level based on allowed RF exposure margin to ensure time-averaged RF exposure is compliant with the regulatory limit)). The substitute value may be a reserve level (e.g., Pᵣₑₛₑᵣᵥₑ), which may be a transmit power level guaranteed to be available, a lower level than the reserve (e.g., zero), or a computed level based on allowed RF exposure margin for that time interval. The substitute value may be a value determined based on an allowed RF exposure margin to ensure time-averaged RF exposure is less than the time-averaged RF exposure limit. The substitute value may be a reserve power or lower, where the reserve power may be equal to the product of Pₗᵢₘᵢₜ and a reserve level (e.g., Pᵣₑₛₑᵣᵥₑ=Pₗᵢₘᵢₜ in milliwatts (mW)*reserve level in linear units=Pₗᵢₘᵢₜ in dBm−reserve level in dB).

In certain aspects, the wireless device may determine the exception transmit power level P_{excep} to be at a power level that is compliant with a time-averaged RF exposure limit associated with an occupational or controlled environment, and the exception transmit power level P_{excep} may be non-compliant with a general public RF exposure limit. In some cases, the time-averaged RF exposure limit associated with an occupational or controlled environment is higher (e.g., up to five times higher) than the

RF exposure limit associated with the general public. The wireless device may apply a scaling factor to the maximum allowed transmit power (P_{max_allowed}) for a time interval determined in accordance with the time-averaged RF exposure limit and past RF exposure. For example, the wireless device may increase the maximum allowed transmit power by the scaling factor. This scaling factor may be less than or equal to the ratio of occupational RF exposure limit to the general public RF exposure limit. In certain aspects, the scaling factor may be a value that is specified or authorized by a regulator or standards organization. The wireless device may determine P_{excep} as a product of the scaling factor (e.g., a=5) and the maximum allowed transmit power (e.g., α·P_{max_allowed}). On the transmit power report side, the wireless device may replace the actual transmit power report with a reduced transmit power report. For example, the wireless device may reduce the actual transmit power report by the scaling factor (e.g., actual transmit power report/α).

FIG. 5 is a flow diagram illustrating example operations 500 for managing a time-averaged RF exposure evaluation for an authorized exception. The operations 500 may be performed, for example, by a wireless device (e.g., the UE 120a) and/or a RF transceiver circuit (e.g., the RF transceiver circuit 300). The operations 500 are described with respect to FIG. 6, which illustrates a graph 600 of example (normalized) transmit powers over time relative to a maximum time-averaged transmit power level (Pₗᵢₘᵢₜ), where an exception transmit power level (P_{excep}) may override a maximum allowed transmit power P_{max_allowed} determined according to a time-averaged evaluation.

The operations 500 may optionally begin, at block 502, where the wireless device may obtain the transmit power used for a particular time interval (e.g., a second time interval 608) in a running time window (T) associated with a time-averaged RF exposure limit. The transmit power may be obtained from a transmit automatic gain control (TxAGC) module at Layer-1 (L1) of a protocol stack. For example, L1 may include the physical radio layer (PHY) of the protocol stack. In certain aspects, the controller 336 of the RF transceiver circuit 300 may obtain (or access) the transmit power used for the particular time interval. The controller 336 may include the TxAGC module and track the transmit power output by the transmit path over time. A transmit power report of the past transmit powers (e.g., the past transmit powers 606) may be representative of actual transmit power(s) within an expected device uncertainty.

At block 504, the wireless device may determine a normalized power report of past transmit powers (e.g., the past transmit powers 606). The normalized power report for a particular time interval (e.g., the second time interval 608) may be a past time-averaged transmit power during a time interval (e.g., the second time interval 608) normalized using Pₗᵢₘᵢₜ. For example, the normalized power report may be equal to the past time-averaged transmit power(s) during the second time interval 608 divided by Pₗᵢₘᵢₜ (e.g., Normalized Power Report=Tx Power Report/Pₗᵢₘᵢₜ), where the transmit power(s) associated with the second time interval 608 are averaged over the second time interval 608. Such normalized power reports may be computed and tracked for multiple time intervals (e.g., corresponding to the past transmit powers 606) belonging to the running time window (T). The wireless device may determine an average of the normalized power reports associated with the past transmit powers 606.

At block 506, the wireless device may adjust the normalized power report in response to detecting an authorized exception to RF exposure compliance, such as detecting an emergency transmission. The wireless device may adjust the normalized power report to be in compliance with a time-averaged RF exposure limit, for example, as described herein. The adjusted power report may be a substitute (or replacement) or dummy (or mock) report used to determine a maximum allowed transmit power (P_{max_allowed}) at block 510. As an example, the wireless device may select a substitute value for the normalized power report, where the substitute value may be selected as the smallest value among the actual transmit power report and the last computed power level based on allowed RF exposure margin to ensure time-averaged RF exposure is compliant with the regulatory or standardized limit.

At block 508, the wireless device may perform a time averaging operation based on the adjusted, normalized power report. The wireless device may determine a normalized exposure margin allowed for the next time interval (e.g., the first time interval 604) in the time window (T) such that the time average of the adjusted version of the normalized power report and the exposure margin for the next time interval satisfy the time-averaged RF exposure limit. In certain aspects, the exposure margin may be the maximum RF exposure that the wireless device can produce and satisfy the time-averaged RF exposure limit. The normalized exposure margin may be the percentage of exposure remaining with respect to the normalized power report and the time-averaged RF exposure limit. For example, the time-averaged RF exposure limit may be satisfied when the time average of the adjusted, normalized power report and the exposure margin for the next time interval (e.g., the first time interval 604) is less than or equal to one (e.g., the normalized RF exposure limit). In terms of the allowable transmit power for the next time interval (e.g., the first time interval 604), the normalized exposure margin represents the percentage of the maximum time-averaged RF exposure power level Pₗᵢₘᵢₜ.

At block 510, the wireless device may determine the maximum allowed transmit power (P_{max_allowed}) for the next time interval (e.g., the first time interval 604). For example, the maximum allowed transmit power (P_{max_allowed}) may be equal to the product of the normalized exposure margin determined at block 508 and Pₗᵢₘᵢₜ.

At block 512, the wireless device may determine a maximum allowed transmit power for the authorized exception (e.g., the exception transmit power level P_{excep}). The wireless device may set the exception transmit power level P_{excep} to be greater than Pₗᵢₘᵢₜ. In some cases, the exception transmit power level P_{excep} may be selected from a range of powers including Pₗᵢₘᵢₜ to Pₘₐₓ (the maximum instantaneous transmit power that the wireless device is capable of outputting). In some cases, the exception transmit power level P_{excep} may be determined by applying a scaling factor on the computed maximum allowed transmit power (P_{max_allowed}) as described herein. Referring to FIG. 6, the wireless device may use the exception transmit power level P_{excep} as the maximum allowed transmit power for the first time interval 604.

At block 514, the wireless device may provide the exception transmit power level P_{excep} 602 to transceiver circuitry (e.g., the RF transceiver circuit 300). For example, the TxAGC module may obtain the scaled version of the exception transmit power level P_{excep} 602 as digital RF information (e.g., a particular gain index associated with an output power of the transmit path 302), and the TxAGC module may control the gains applied to circuitry in the transmit path to output a signal (e.g., an analog RF signal) at the transmit power associated with the digital RF information.

In certain aspects, the operations 500 may optionally begin at block 512 in response to detecting an authorized exception to RF exposure compliance. The wireless device may adjust the transmit power report at block 506 until the transmission associated with the authorized exception has ended.

For certain aspects, the wireless device may temporarily refrain from performing the time-averaged RF exposure evaluation described herein with respect to FIG. 5. For example, the wireless device may perform the operations 500 at blocks 512 and 514 in response to detecting an authorized exception to RF exposure compliance. During the transmission associated with the authorized exception, the wireless device may refrain from performing the operations associated with any of blocks 502, 504, 506, 508, and 510.

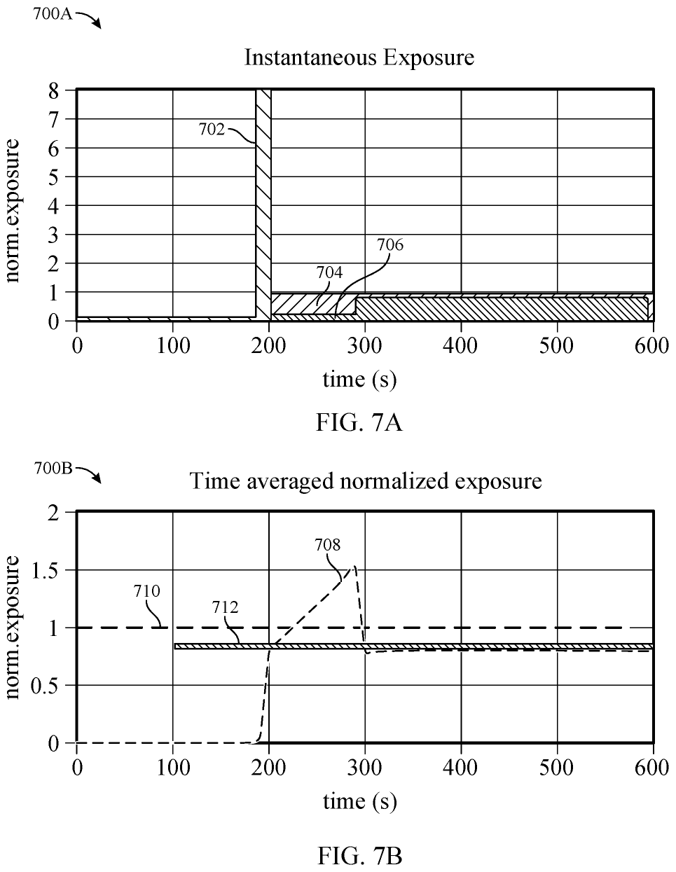

FIG. 7A is an example plot 700A illustrating instantaneous normalized exposure over time associated with a wireless device. In this example, shortly before the 200 second mark, the wireless device may output a transmission burst that uses all or most of the exposure margin associated with a time-averaged RF exposure limit. The instantaneous exposure 702 may correspond to exposure produced by the transmission burst. To be in compliance with the RF exposure limit, the wireless device may wait for the duration of the next time window to allow a subsequent transmission, or the wireless device may transmit at a reserve level for the remainder of the time window (e.g., 100 seconds) before allowing to transmit at Pₗᵢₘᵢₜ continuously in the next time window as depicted by 706. In response to detecting an authorized exception to RF exposure compliance, the wireless device may transmit a signal at an exception transmit power (e.g., 0.8*Pₗᵢₘᵢₜ). In order to ensure smooth operation of the time-averaging evaluation, the wireless device may select the smallest value among the actual exposure 704 and an exposure margin 706 determined by time-averaging algorithm as a substitute for the transmit power report, for example, as described herein with respect to FIG. 5. The wireless device may adjust the exposure margin 706 over time as more margin becomes available based on past exposure. The wireless device may increase the exposure margin 706 after the wireless device is transmitting in compliance with the RF exposure limit, for example, as depicted at about the 280 second mark. In some cases, the exposure margin 706 may be adjusted to be equal to Pₗᵢₘᵢₜ when the past exposure associated with the transmission is in compliance with the time-averaged RF exposure limit. For example, the exposure margin 706 maybe adjusted to a value of 1.0 from 280 seconds to 600 seconds as the time-averaged algorithm allows the wireless device to transmit continuously at Pₗᵢₘᵢₜ in subsequent time windows.

FIG. 7B is an example plot 700B illustrating the time-averaged normalized exposure corresponding to FIG. 7A. Assuming the wireless device transmits at the same power level after the 200 second mark (e.g., P_{excep}=0.8*Pₗᵢₘᵢₜ), the time-averaged RF exposure 708 may exceed the maximum time-averaged transmit power level Pₗᵢₘᵢₜ 710 for a portion of a time window (e.g., less than 100 seconds). The time-averaged RF exposure 708 may drop below the maximum time-averaged transmit power level Pₗᵢₘᵢₜ 710 shortly before the 300 second mark, where the time-averaged RF exposure may settle to the power level of the exception transmit power level P_{excep}. In this example, the exception transmit power level may be equal to or less than an exposure margin 712, which allows leftover margin (e.g., (1−0.8)*Pₗᵢₘᵢₜ=0.2*Pₗᵢₘᵢₜ) to be available for other transmissions.

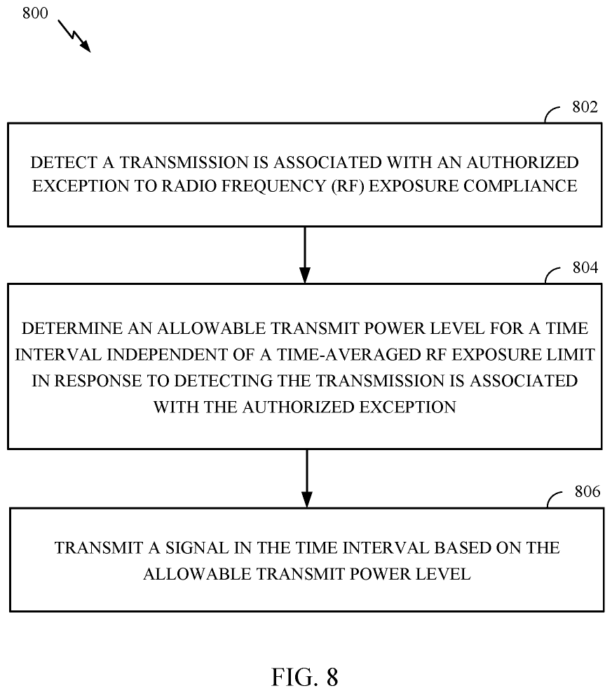

FIG. 8 is a flow diagram illustrating example operations 800 for wireless communication, in accordance with certain aspects of the present disclosure. The operations 800 may be performed, for example, by a wireless device (e.g., the UE 120a in the wireless communication network 100). The operations 800 may be implemented as software components that are executed and run on one or more processors (e.g., controller/processor 280 of FIG. 2). Further, the transmission and/or reception of signals by the wireless device in the operations 800 may be enabled, for example, by one or more antennas (e.g., antennas 252 of FIG. 2). In certain aspects, the transmission and/or reception of signals by the wireless device may be implemented via a bus interface of one or more processors (e.g., controller/processor 280) obtaining and/or outputting signals.

The operations 800 may optionally begin, at block 802, where the wireless device may detect a transmission is associated with an authorized exception to RF exposure compliance. The authorized exception to RF exposure compliance may allow the wireless device to temporarily exceed a time-averaged RF exposure limit, for example, as described herein with respect to FIGS. 5, 6, 7A, and 7B. In certain aspects, an authorized exception may include an emergency transmission. In some cases, the wireless device may perform this detection before outputting the transmission, and the wireless device may perform one or more actions in response to this detection.

At block 804, the wireless device may determine an allowable transmit power level (e.g., P_{excep}) for a time interval (e.g., the first time interval 604) independent of a time-averaged RF exposure limit in response to detecting the transmission is associated with the authorized exception. For example, the wireless device may select the transmit power to be less than or equal to a maximum instantaneous transmit power (e.g., Pₘₐₓ) that the wireless device is capable of outputting. The time interval may include at least a portion of a running time window associated with the time-averaged RF exposure limit.

At block 806, the wireless device may transmit a signal in the time interval based on the allowable transmit power level. The wireless device may transmit the signal at a power level that is less than or equal to the allowable transmit power level. Transmitting the signal may include transmitting any of various communications, such as a text message, video call, voice call, data transmission, etc. The wireless device may transmit the signal to any of various other wireless devices, such as a base station (e.g., the BS 110a) or a user equipment (e.g., the UE 120). Transmitting the signal may use any of various RATs, such as CDMA, E-UTRA, NR, IEEE 802.11, non-terrestrial network (NTN) communications, etc.

The wireless device may determine the allowable transmit power level (P_{excep}) to be any of various power levels. In some cases, the wireless device may determine the allowable transmit power level to be equal to a power level associated with a transmit power limit (e.g., Pₗᵢₘᵢₜ) corresponding to the time-averaged RF exposure limit. In certain cases, the allowable transmit power level may be less than Pₗᵢₘᵢₜ. In certain aspects, the wireless device may select the allowable transmit power level between a power level associated with a transmit power limit (e.g., Pₗᵢₘᵢₜ) corresponding to the time-averaged RF exposure limit and a maximum instantaneous transmit power (e.g., Pₘₐₓ) that the wireless device is capable of outputting. To determine the allowable transmit power level for the authorized exception transmission, the wireless device may allow non-compliance with the time-averaged RF exposure limit in the time interval based on past RF exposure and the transmit power for the time interval, for example, as described herein with respect to FIG. 7B.

In certain aspects, from a software operation perspective, to allow for smooth operation, the wireless device may adjust an RF exposure report or a transmit power report (e.g., an RF exposure report or a transmit power report associated with the past transmit powers 606) to be in compliance with the time-averaged RF exposure limit, for example, as described herein with respect to FIGS. 5 and 6. The RF exposure report or transmit power report may be indicative of the RF exposure or transmit powers produced by the wireless device in a running time window associated with the time-averaged RF exposure limit. In certain cases, to adjust the RF exposure report or the transmit power report, the wireless device may select a smallest value among multiple values as the RF exposure report (e.g., min(transmit power report/Pₗᵢₘᵢₜ, previous computed exposure margin for time-averaged RF exposure compliance)) or the transmit power report (e.g., min(actual transmit power report, the last computed power level based on allowed RF exposure margin to ensure time-averaged RF exposure is compliant with the regulatory limit)). The multiple values may include a current value of the RF exposure report or transmit power report and a substitute value for the RF exposure report or transmit power report. The wireless device may determine the substitute value as a value corresponding to a reserve power (e.g., Pᵣₑₛₑᵣᵥₑ) associated with the time-averaged RF exposure limit. In some cases, to adjust the RF exposure report, the wireless device may set the RF exposure report or the transmit power report to a particular value. The particular value may include a first value indicative of no past RF exposure (e.g., zero, which is equivalent to disabling the time-averaged RF exposure evaluation during the authorized exception transmission) or a second value corresponding to a reserve power level (e.g., Pᵣₑₛₑᵣᵥₑ).

The wireless device may override the time-averaged RF exposure evaluation with the transmit power determined at block 804, for example, as described herein with respect to FIGS. 5 and 6. The wireless device may determine an initial transmit power level (e.g., P_{max_allowed}) based on the adjusted RF exposure report in compliance with the time-averaged RF exposure limit. The wireless device may replace the initial transmit power level with the allowable transmit power level (e.g., P_{excep}), for example, as described herein with respect to block 512. Instead of using the maximum allowed transmit power (P_{max_allowed}) for the transmission, the wireless device may use the exception transmit power level P_{excep}, for example, as described herein with respect to block 512.

In certain aspects, the wireless device may apply an RF exposure limit associated with an occupational or controlled environment to determine the transmit power. For example, the wireless device may determine the transmit power is in compliance with a first RF exposure limit associated with an occupational or controlled environment, and the wireless device may allow the transmit power to be in non-compliance with a second RF exposure limit associated with a general public environment. In certain cases, to determine the transmit power that is in compliance with the first RF exposure limit associated with an occupational or controlled environment, the wireless device may increase the maximum time-averaged RF exposure power level Pₗᵢₘᵢₜ by a scaling factor (e.g., a=5). In such cases, the maximum allowed transmit power (P_{max_allowed}) may automatically increase in proportion to the maximum time-averaged RF exposure power level Pₗᵢₘᵢₜ, e.g., notwithstanding past transmissions under the first RF exposure limit or the second RF exposure limit. This scaling factor may be less than or equal to the ratio of occupational RF exposure limit to the general public RF exposure limit, or the scaling factor may be a value that is specified or authorized by a regulator or standards organization.

In other cases, the wireless device may keep the maximum time-averaged RF exposure level Pₗᵢₘᵢₜ set according to the second RF exposure limit associated with a general public environment, and increase the maximum allowed transmit power (P_{max_allowed}) by a scaling factor (e.g., a=5), where the maximum allowed transmit power (P_{max_allowed}) is determined according to a time-averaged RF exposure evaluation. This scaling factor may be less than or equal to the ratio of occupational RF exposure limit to the general public RF exposure limit, or the scaling factor may be a value that is specified or authorized by a regulator or standards organization. For example, the wireless device may determine P_{excep} as a product of the scaling factor (e.g., a=5) and the maximum allowed transmit power (e.g., α·P_{max_allowed}). The wireless device may replace the actual transmit power report with a reduced transmit power report. For example, the wireless device may reduce the actual transmit power report by the scaling factor (e.g., actual TX power report/α).

In certain aspects, the wireless device may apply different RF exposure limits to determine the transmit power, based on the particular application/transmission scenario. For example, the wireless device may have a dual certification in which the wireless device applies a (first) RF exposure limit associated with an occupational or controlled environment when the wireless device is used in the occupational or controlled environment for certain applications (e.g., radio frequency identification (RFID) transmissions or emergency communications, for example 9-1-1) and applies a (second) RF exposure limit associated with a general public environment when the wireless device is used in the general public environment.

For certain aspects, the wireless device may refrain from checking if the transmission is in compliance with the time-averaged RF exposure limit. The wireless device may temporarily refrain from performing a time-averaged RF exposure evaluation, for example, as described herein with respect to FIGS. 5 and 6. The wireless device may refrain from performing the time-averaged RF exposure evaluation for at least a duration of the transmission.

In certain aspects, to detect the transmission is associated with an authorized exception, the wireless device may detect the transmission is associated with an emergency. The emergency transmission may include a (video or voice) call or text to an emergency hotline (e.g., 9-1-1 in the United States). The wireless device may detect the transmission is associated with the emergency based at least in part on at least one of: a recipient of the transmission, a destination phone number associated with the transmission, or a priority service (e.g., a government authorized priority service such as Wireless Priority Service) associated with the transmission. The wireless device may store or obtain information associated with emergency transmissions, where the information indicates which transmission(s) qualify as emergency transmissions. The wireless device may inspect the transmission to determine if the transmission qualifies as an emergency transmission based on the information associated with the emergency transmissions. For example, the wireless device may inspect the phone number dialed for a call or text message, and when the number matches an emergency phone number (e.g., 9-1-1), the wireless device may apply a temporary exception to the time-averaged RF exposure limit for the emergency call as described herein. The phone number or other exception identifier may be stored on the wireless device, for example in an initial configuration or based on information exchanged with (or obtained from) a radio access network (e.g., a network-specific configuration). For example, when registering with a network, the network may provide to the wireless device a set of emergency contact information or authorized exceptions. In some examples, a network may respond to a received communication with an indicator that a subsequent portion of the communication may be treated as an authorized exception. In some examples, an authorized exception is only associated with one RAT (e.g., an NTN) or with certain RATs. In some such examples, only certain communications on that RAT(s), for example a 9-1-1 communication, may be an authorized exception. In other examples, communications meeting certain criteria, as described herein, may be considered an authorized exception, regardless of on which RAT such communications are transmitted.

The recipient of the transmission may include an identifier associated with the recipient, an address of the recipient (e.g., an internet protocol (IP) address, a medium access control address, an email address, etc.), a uniform resource locator (URL) of the recipient, etc. In certain cases where the emergency transmission is an internet communication (e.g., an online chat service or video or voice over the internet), the wireless device may detect the emergency transmission based on the recipient of the transmission. The recipient of the transmission may be associated with a particular online emergency service, which may not be associated with a specific phone number. The wireless device may inspect header information of certain communication protocols, such as Hypertext Transfer Protocol (HTTP) or the Internet Protocol. For example, the wireless device may identify that the host of an HTTP request message (e.g., HTTP GET) matches the URL or IP address of an emergency service provider, such as a police department or suicide prevention service. The wireless device may apply a temporary exception to the time-averaged RF exposure limit for the emergency transmission as described herein.

The recipient of the transmission or the destination phone number may correspond to at least one of: an emergency contact number, an emergency hotline, a police department, a fire department, a coast guard, a border patrol, an emergency medical care service, or an ambulance service. The emergency hotline may include a 9-1-1 call center in the United States or Canada or similar emergency call center in another country, such as 1-1-2 in France, Germany, or Italy (or other European countries), or such as the emergency hotline numbers 1-2-0, 1-1-9, 1-1-0, and 1-2-2 in China. In certain aspects, the emergency hotline may include a suicide prevention hotline or a poison control center, for example. The wireless device may inspect the phone number dialed for a call, text, or other communication. When the phone number dialed matches an emergency phone number (e.g., a police department), the wireless device may apply a temporary exception to the time-averaged RF exposure limit for the emergency call as described herein.

The priority service may provide priority to certain authorized users, such as first responders or government officials. The priority service may include Wireless Priority Service in the United States or an equivalent service in another country. Authorized users may include, for example, a federal, state, local, and tribal police department, fire department, public safety answering point or 9-1-1 call center, an emergency medical service, essential healthcare provider, or any other organization that uses telecommunication services for the public health, safety, maintenance of public order, or enforcement of laws. An authorized user can receive calling queue priority via the priority service by dialing a specific sequence (e.g., *272) before the destination phone number. The wireless device may inspect the phone number dialed for a call or text. When the phone number dialed begins with the priority service sequence (e.g., *272), the wireless device may apply a temporary exception to the time-averaged RF exposure limit for the emergency call as described herein

While the examples depicted in FIGS. 1-8 are described herein with respect to a UE performing the various methods to facilitate understanding, aspects of the present disclosure may also be applied to other wireless devices, such as a wireless station, an access point, a base station and/or a customer premises equipment (CPE), performing the methods described herein. Further, while the examples are described with respect to communications between a UE (or other wireless device) and a network entity, the UE or other wireless device may be communicating with a device other than a network entity, for example another UE or with another device in a user's home that is not a network entity, for example. Likewise, while certain aspects describe authorized exceptions in the context of emergency transmissions, such as a 9-1-1 call, note that an authorized exception may include any authorized transmission specified or authorized by a regulator or standards organization.

### Example Communications Device

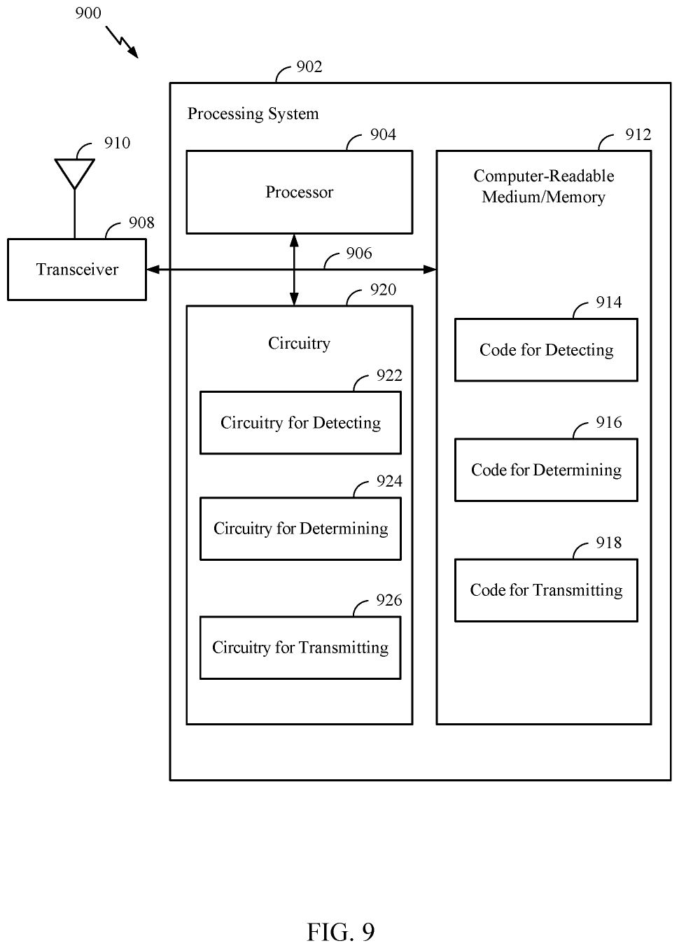

FIG. 9 illustrates a communications device 900 (e.g., the UE 120) that may include various components (e.g., corresponding to means-plus-function components) configured to perform operations for the techniques disclosed herein, such as the operations 500 illustrated in FIG. 5, the operations illustrated in FIG. 8, or other operations described herein for managing exceptions to RF exposure compliance. The communications device 900 includes a processing system 902, which may be coupled to a transceiver 908 (e.g., a transmitter and/or a receiver). The transceiver 908 is configured to transmit and receive signals for the communications device 900 via an antenna 910, such as the various signals as described herein. The processing system 902 may be configured to perform processing functions for the communications device 900, including processing signals received and/or to be transmitted by the communications device 900.

The processing system 902 includes a processor 904 coupled to a computer-readable medium/memory 912 via a bus 906. In certain aspects, the computer-readable medium/memory 912 is configured to store instructions (e.g., computer-executable code) that when executed by the processor 904, cause the communications device 900 to perform the operations 500 illustrated in FIG. 5, operations 800 illustrated in FIG. 8, or other operations for performing the various techniques discussed herein for managing exceptions to RF exposure compliance. In certain aspects, computer-readable medium/memory 912 stores code for detecting 914, code for determining (or selecting, adjusting, allowing, permitting, setting, or replacing) 916, code for transmitting (or outputting) 918, or any combination thereof.

In certain aspects, the processing system 902 has circuitry 920 configured to implement the code stored in the computer-readable medium/memory 912. In certain aspects, the circuitry 920 is coupled to the processor 904 and/or the computer-readable medium/memory 912 via the bus 906. For example, the circuitry 920 includes circuitry for detecting 922, circuitry for determining (or selecting, adjusting, allowing, permitting, setting, or replacing), circuitry for transmitting (or outputting) 926, or any combination thereof.

In some examples, means for transmitting or sending (or means for outputting for transmission) may include the transceivers 254 and/or antenna(s) 252 of the UE 120 illustrated in FIG. 2 and/or transceiver 908 and antenna 910 of the communications device 900 in FIG. 9.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for detecting and/or means for determining (or selecting, adjusting, allowing, permitting, setting, or replacing) may include various processing system components, such as: the processor 904 in FIG. 9, or aspects of the UE 120 depicted in FIG. 2, including receive processor 258, transmit processor 264, TX MIMO processor 266, and/or controller/processor 280.

### EXAMPLE ASPECTS

Implementation examples are described in the following numbered clauses:

Aspect 1: A method of wireless communication by a wireless device, comprising: detecting a transmission is associated with an authorized exception to radio frequency (RF) exposure compliance; determining an allowable transmit power level for a time interval independent of a time-averaged RF exposure limit in response to detecting the transmission is associated with the authorized exception; and transmitting a signal in the time interval based on the allowable transmit power level.

Aspect 2: The method of Aspect 1, wherein determining the allowable transmit power level comprises determining the allowable transmit power level to be equal to a power level associated with a transmit power limit corresponding to the time-averaged RF exposure limit.

Aspect 3: The method of Aspect 1, wherein determining the allowable transmit power level comprises determining the allowable transmit power level to be a maximum instantaneous transmit power that the wireless device is capable of outputting.

Aspect 4: The method of Aspect 1, wherein determining the allowable transmit power level comprises selecting the allowable transmit power level between a power level associated with a transmit power limit corresponding to the time-averaged RF exposure limit and a maximum instantaneous transmit power that the wireless device is capable of outputting.

Aspect 5: The method according to any of Aspects 1-4, wherein determining the allowable transmit power level comprises allowing non-compliance with the time-averaged RF exposure limit in the time interval based on past RF exposure and the allowable transmit power level for the time interval.

Aspect 6: The method according to any of Aspects 1-5, further comprising refraining from performing a time-averaged RF exposure evaluation for at least a duration of the transmission.

Aspect 7: The method according to any of Aspects 1-6, further comprising adjusting an RF exposure report or a transmit power report to be in compliance with the time-averaged RF exposure limit.

Aspect 8: The method according to Aspect 7, wherein determining the allowable transmit power level comprises: determining an initial transmit power level based on the adjusted RF exposure report or the adjusted transmit power report in compliance with the time-averaged RF exposure limit; and replacing the initial transmit power level with the allowable transmit power level.

Aspect 9: The method according to any of Aspects 7-8, wherein adjusting the RF exposure report or transmit power report comprises selecting a smallest value among a plurality of values as the RF exposure report or transmit power report.

Aspect 10: The method of Aspect 9, wherein the plurality of values includes a current value of the RF exposure report or transmit power report and a substitute value for the RF exposure report or transmit power report.

Aspect 11: The method of Aspect 10, further comprising determining the substitute value as a value corresponding to a reserve power associated with the time-averaged RF exposure limit.

Aspect 12: The method according to any of Aspects 7-8, wherein adjusting the RF exposure report or transmit power report comprises setting the RF exposure report or transmit power report to a particular value.

Aspect 13: The method of Aspect 12, wherein the particular value comprises a first value indicative of no past RF exposure or a second value corresponding to a reserve power level.

Aspect 14: The method according to any of Aspects 7-12, wherein the RF exposure report is indicative of the RF exposure produced by the wireless device in a running time window associated with the time-averaged RF exposure limit.

Aspect 15: The method according to any of Aspects 1-14, wherein determining the allowable transmit power level comprises determining the allowable transmit power level is in compliance with a first RF exposure limit associated with an occupational or controlled environment.

Aspect 16: The method of Aspect 15, wherein determining the allowable transmit power level comprises permitting the allowable transmit power level to be in non-compliance with a second RF exposure limit associated with a general public environment.

Aspect 17: The method of Aspect 15, wherein: determining the allowable transmit power level is in compliance with the first RF exposure limit comprises determining the allowable transmit power level to be equal to a power level associated with a first transmit power limit corresponding to the time-averaged RF exposure limit; and the first transmit power limit is higher than a second transmit power limit corresponding to the time-averaged RF exposure limit.

Aspect 18: The method of Aspect 15, wherein: determining the allowable transmit power level is in compliance with the first RF exposure limit comprises determining the allowable transmit power level to be equal to a first power level associated with a transmit power limit corresponding to the time-averaged RF exposure limit; and the first power level is higher than a second power level associated with a transmit power limit corresponding to a second RF exposure limit associated with a general public environment.

Aspect 19: The method according to any of Aspects 1-18, wherein detecting the transmission is associated with the authorized exception comprises detecting the transmission is associated with an emergency.

Aspect 20: The method of Aspect 19, wherein detecting the transmission is associated with the emergency comprises detecting the transmission is associated with the emergency based at least in part on at least one of: a recipient of the transmission, a destination phone number associated with the transmission, or a priority service associated with the transmission.

Aspect 21: The method of Aspect 20, wherein the recipient or the destination phone number corresponds to at least one of: an emergency contact number, an emergency hotline, a police department, a fire department, a coast guard, a border patrol, an emergency medical care service, or an ambulance service.

Aspect 22: The method of Aspect 20 or 21, wherein the priority service includes a wireless priority service.

Aspect 23: An apparatus comprising: one or more memories collectively storing executable instructions; and one or more processors coupled to the one or more memories, the one or more processors being collectively configured to execute the executable instructions and cause the apparatus to perform a method in accordance with any of Aspects 1-22.

Aspect 24: An apparatus comprising means for performing a method in accordance with any of Aspects 1-22.

Aspect 25: A non-transitory computer-readable medium comprising computer-executable instructions that, when executed by one or more processors of a processing system, cause the processing system to perform a method in accordance with any of Aspects 1-22.

Aspect 26: A computer program product embodied on a computer-readable storage medium comprising code for performing a method in accordance with any of Aspects 1-22.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g., 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a closed subscriber group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a customer premises equipment (CPE), a cellular phone, a smart phone, a personal digital assistant (PDA), a wireless modem, a wireless device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within the entity's service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, generating, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a UE (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer-readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (random access memory), flash memory, ROM (read-only memory), PROM (programmable read-only memory), EPROM (erasable programmable read-only memory), EEPROM (electrically erasable programmable read-only memory), registers, magnetic disks, optical disks, hard drives, or any other suitable storage medium, or any combination thereof. The machine-readable media may be embodied in a computer program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 8.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, or a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method of wireless communication by a wireless device, comprising:
detecting a transmission is associated with an authorized exception to radio frequency (RF) exposure compliance;
determining an allowable transmit power level for a time interval independent of a time-averaged RF exposure limit in response to detecting the transmission is associated with the authorized exception; and
transmitting a signal in the time interval based on the allowable transmit power level.

2. The method of claim 1, wherein determining the allowable transmit power level comprises determining the allowable transmit power level to be equal to a power level associated with a transmit power limit corresponding to the time-averaged RF exposure limit.

3. The method of claim 1, wherein determining the allowable transmit power level comprises determining the allowable transmit power level to be a maximum instantaneous transmit power that the wireless device is capable of outputting.

4. The method of claim 1, wherein determining the allowable transmit power level comprises selecting the allowable transmit power level between a power level associated with a transmit power limit corresponding to the time-averaged RF exposure limit and a maximum instantaneous transmit power that the wireless device is capable of outputting.

5. The method of claim 1, wherein determining the allowable transmit power level comprises allowing non-compliance with the time-averaged RF exposure limit in the time interval based on past RF exposure and the allowable transmit power level for the time interval.

6. The method of claim 1, further comprising refraining from performing a time-averaged RF exposure evaluation for at least a duration of the transmission.

7. The method of claim 1, further comprising adjusting an RF exposure report or a transmit power report to be in compliance with the time-averaged RF exposure limit.

8. The method of claim 7, wherein determining the allowable transmit power level comprises:
determining an initial transmit power level based on the adjusted RF exposure report or the adjusted transmit power report in compliance with the time-averaged RF exposure limit; and
replacing the initial transmit power level with the allowable transmit power level.

9. The method of claim 7, wherein adjusting the RF exposure report or transmit power report comprises selecting a smallest value among a plurality of values as the RF exposure report or transmit power report.

10. The method of claim 9, wherein the plurality of values includes a current value of the RF exposure report or transmit power report and a substitute value for the RF exposure report or transmit power report.

11. The method of claim 10, further comprising determining the substitute value as a value corresponding to a reserve power associated with the time-averaged RF exposure limit.

12. The method of claim 7, wherein adjusting the RF exposure report or transmit power report comprises setting the RF exposure report or transmit power report to a particular value.

13. The method of claim 12, wherein the particular value comprises a first value indicative of no past RF exposure or a second value corresponding to a reserve power level.

14. The method of claim 7, wherein the RF exposure report is indicative of the RF exposure produced by the wireless device in a running time window associated with the time-averaged RF exposure limit.

15. The method of claim 1, wherein determining the allowable transmit power level comprises determining the allowable transmit power level is in compliance with a first RF exposure limit associated with an occupational or controlled environment.

16. The method of claim 15, wherein determining the allowable transmit power level comprises permitting the allowable transmit power level to be in non-compliance with a second RF exposure limit associated with a general public environment.

17. The method of claim 15, wherein:
determining the allowable transmit power level is in compliance with the first RF exposure limit comprises determining the allowable transmit power level to be equal to a power level associated with a first transmit power limit corresponding to the time-averaged RF exposure limit; and
the first transmit power limit is higher than a second transmit power limit corresponding to the time-averaged RF exposure limit.

18. The method of claim 15, wherein:
determining the allowable transmit power level is in compliance with the first RF exposure limit comprises determining the allowable transmit power level to be equal to a first power level associated with a transmit power limit corresponding to the time-averaged RF exposure limit; and
the first power level is higher than a second power level associated with a transmit power limit corresponding to a second RF exposure limit associated with a general public environment.

19. The method of claim 1, wherein detecting the transmission is associated with the authorized exception comprises detecting the transmission is associated with an emergency.

20. The method of claim 19, wherein detecting the transmission is associated with the emergency comprises detecting the transmission is associated with the emergency based at least in part on at least one of:
a recipient of the transmission,
a destination phone number associated with the transmission, or
a priority service associated with the transmission.

21. The method of claim 20, wherein the recipient or the destination phone number corresponds to at least one of:
an emergency contact number,
an emergency hotline,
a police department,
a fire department,
a coast guard,
a border patrol,
an emergency medical care service, or
an ambulance service.

22. The method of claim 20, wherein the priority service includes a wireless priority service.

23. An apparatus for wireless communication, comprising:
one or more memories collectively storing executable instructions; and
one or more processors coupled to the one or more memories, the one or more processors being collectively configured to execute the executable instructions to cause the apparatus to:
detect a transmission is associated with an authorized exception to radio frequency (RF) exposure compliance,
determine an allowable transmit power level for a time interval independent of a time-averaged RF exposure limit in response to detecting the transmission is associated with the authorized exception, and
transmit a signal in the time interval based on the allowable transmit power level.

24. The apparatus of claim 23, wherein to determine the allowable transmit power level, the one or more processors are collectively configured to execute the executable instructions to cause the apparatus to determine the allowable transmit power level to be equal to a power level associated with a transmit power limit corresponding to the time-averaged RF exposure limit.

25. The apparatus of claim 23, wherein to determine the allowable transmit power level, the one or more processors are collectively configured to execute the executable instructions to cause the apparatus to determine the allowable transmit power level to be a maximum instantaneous transmit power that the apparatus is capable of outputting.

26. The apparatus of claim 23, wherein to determine the allowable transmit power level, the one or more processors are collectively configured to execute the executable instructions to cause the apparatus to select the allowable transmit power level between a power level associated with a transmit power limit corresponding to the time-averaged RF exposure limit and a maximum instantaneous transmit power that the apparatus is capable of outputting.

27. The apparatus of claim 23, wherein to determine the allowable transmit power level, the one or more processors are collectively configured to execute the executable instructions to cause the apparatus to allow non-compliance with the time-averaged RF exposure limit in the time interval based on past RF exposure and the allowable transmit power level for the time interval.

28. The apparatus of claim 23, wherein to determine the allowable transmit power level, the one or more processors are collectively configured to execute the executable instructions to cause the apparatus to determine the allowable transmit power level is in compliance with a first RF exposure limit associated with an occupational or controlled environment.

29. An apparatus for wireless communication, comprising:
means for detecting a transmission is associated with an authorized exception to radio frequency (RF) exposure compliance;
means for determining an allowable transmit power level for a time interval independent of a time-averaged RF exposure limit in response to detecting the transmission is associated with the authorized exception; and
means for transmitting a signal in the time interval based on the allowable transmit power level.

30. A non-transitory computer-readable medium having instructions stored thereon, which when executed by an apparatus, cause the apparatus to perform an operation comprising:
detecting a transmission is associated with an authorized exception to radio frequency (RF) exposure compliance;
determining an allowable transmit power level for a time interval independent of a time-averaged RF exposure limit in response to detecting the transmission is associated with the authorized exception; and
transmitting a signal in the time interval based on the allowable transmit power level.
